(19) United States
(12) Patent Application Publication
(10) Pub. No.: US 2017/0211627 A1
(43) Pub. Date: Jul. 27, 2017

(54) APPARATUS AND METHOD FOR MAKING BEARING COMPONENT WITH IMPROVED LUBRICITY

(71) Applicant: NSK Americas, Inc., Ann Arbor, MI (US)

(72) Inventors: Anderson Ferreira Da Silva, Suzano (BR); Marcos Vilodres Campanha, Sao Paulo (BR)

(21) Appl. No.: 15/326,838

(22) PCT Filed: Jul. 16, 2015
(86) PCT No.: PCT/US2015/040693

§ 371 Date: Jan. 17, 2017

Related U.S. Application Data
(60) Provisional application No. 62/025,200, filed on Jul. 16, 2014.
(60) Provisional application No. 62/025,182, filed on Jul. 16, 2014.

(51) Int. Cl. F16C 33/64; B23K 26/00; B23K 26/352; C21D 9/40; F16C 33/66; B23K 26/70; C21D 1/09; B23K 26/08; F16C 33/62

(52) U.S. Cl. CPC F16C 33/64; B23K 26/0823; B23K 26/0006; B23K 26/0066; B23K 26/352; F16C 33/62; F16C 33/6696; B23K 26/703; C21D 1/09; C21D 9/40; B23K 2203/172

(57) ABSTRACT

Apparatuses (10) for and methods of imparting a laser surface treatment to an exposed outer surface (12) of a rolling bearing component having a carbon-containing coating thereon. The apparatus (10) includes a support housing structure (16). A rolling bearing carrier has a surface adapted to receive and engage at least one ring of a rolling bearing. A motor (22) mounted to the support housing structure (16) is coupled with the carrier and adapted for rotatably driving the carrier. A laser beam emitter aims a laser beam at an exposed surface (12) of the rolling bearing component. The carrier is rotated while the rolling bearing component is in generally opposing relationship with the laser beam so that energy from the beam causes at least a portion of the coating on the bearing component to volatilize and be removed while also causing at least a portion of a carbon content of the coating to diffuse into the bearing component.

### CLAIM OF BENEFIT OF FILING DATE AND PRIORITY

The present application claims the benefit of the filing date of, and priority to, U.S. Application No. 62/025,182, filed Jul. 16, 2014, which is hereby incorporated by reference in its entirety, and U.S. Application No. 62/025,200, filed Jul. 16, 2014, which is hereby incorporated by reference in its entirety.

### FIELD

In general, the present teachings relate to improved bearings, and particularly to rolling bearings that exhibit improved lubricity.

### BACKGROUND

Notwithstanding efforts over the years to improve bearing life and/or reduce the coefficient of friction of bearing surfaces, there still remains a need for additional bearing structures that exhibit one or both of the foregoing.

The ability to reduce friction by surface treatment of bearing steel has been the subject of a paper delivered by A. F. da Silva et al., “Reduction Of Friction Promoted By Surface Treatment By CO Laser In AISI 52100 Steel” (delivered at First International Brazilian Conference on Tribology TriboBr, Nov. 24-26, 2010, Rio de Janeiro—RJ—Brazil), incorporated by reference.

The following U.S. patent documents may be related to the present teachings: U.S. Pat. Nos. 5,529,646; 5,725,807; 5,861,067; 5,879,480; 6,309,475; 6,350,326; 6,655,845; 7,063,755; 7,687,112; 8,454,241; and 8,485,730, all of which are incorporated by reference herein for all purposes.

There remains a need for alternative equipment and methods for altering the microstructure of bearing components, such as rolling bearing components.

### SUMMARY

The present teachings make use of a simple, yet elegant, approach to the construction of an improved bearing. In one of its aspects, the teachings relate to an apparatus that can be employed for selectively imparting a localized surface treatment to a surface of a bearing component, such as a rolling bearing that includes an outer ring, an inner ring concentrically located within the outer ring, and which may include at least one rolling element between the outer and the inner ring. For example, the teachings envision the use of an apparatus herein for treating an inner surface of an outer ring, an outer surface of an inner ring or both.

In one general sense, the teachings herein relate to an improved apparatus for providing a laser treated surface of a rolling bearing component, such as a steel rolling bearing component. In particular, the apparatus is configured for imparting a laser surface treatment to at least a portion of a surface of a rolling bearing component having a carbon-containing coating thereon. The laser surface treatment is such that it can cause an amount of the carbon-containing coating to diffuse into the rolling bearing component to a desired depth thereby selectively imparting a carbon gradient from the treated surface and may also leave a deposit of a graphitic coating on the treated surface.

The apparatus may include a support housing structure. A rolling bearing carrier component may be employed having a longitudinal axis and a surface adapted to receive and engage at least one ring to be employed as part of a rolling bearing. A motor may be mounted to the support housing structure and coupled with the rolling bearing carrier, the motor being adapted for rotatably driving the carrier. A laser beam emitter may be adapted for emitting a laser beam that is aimed at an exposed surface of the ring. The carrier is rotated while the at least one ring is in generally opposing relationship with the beam of the laser beam emitter so that energy from the beam causes at least a portion of the coating on the ring to volatilize and be removed while also causing at least a portion of a carbon content of the carbon-containing coating to diffuse into the bearing component. An associated method of use is also contemplated.

The apparatus may be in the form of one or more embodiments which may be suitably modified for treating an outer surface of an inner ring of a rolling bearing component, or an inner surface of an outer ring of a rolling bearing component. For example, in one aspect, there is envisioned an apparatus for imparting a laser surface treatment to an exposed outer peripheral surface of an inner ring of a rolling bearing having a carbon-containing coating thereon. The apparatus includes a support housing structure, a spindle shaft having a longitudinal axis and an outer surface adapted to receive and engage at least one inner ring of the rolling bearing; and a motor mounted to the support housing structure and coupled with the spindle shaft, the motor being adapted for rotatably driving the spindle shaft. The apparatus may include a laser beam emitter adapted for emitting a laser beam that is aimed at the exposed peripheral surface of the at least one inner ring. In this manner the spindle shaft may be rotated while the at least one rolling bearing is in generally opposing relationship with the beam of the laser beam emitter so that energy from the beam causes at least a portion of the coating on the exposed peripheral surface of the at least one inner ring to volatilize and be removed from the at least one ring while also causing at least a portion of a carbon content of the carbon-containing coating to diffuse into the at least one inner ring.

In another aspect, there is envisioned an apparatus for imparting a laser surface treatment to an exposed inner peripheral surface of an outer ring of a rolling bearing having a carbon-containing coating thereon. Such apparatus includes a support housing structure, a casing having a longitudinal axis and an inner surface adapted to receive and engage an outer surface of at least one outer ring of the rolling bearing; and a motor mounted to the support housing structure and coupled with the casing, the motor being adapted for rotatably driving the casing. The apparatus may include a laser beam emitter adapted for emitting a laser beam that is aimed at the exposed inner peripheral surface of the at least one outer ring at an angle (a) that is generally not perpendicular to the longitudinal axis of the casing (e.g., it may be at an angle relative to an axis that is transverse to the longitudinal axis of the casing). In this manner, the casing may be rotated while the at least one rolling bearing is in generally opposing relationship with the beam of the laser beam emitter so that energy from the beam causes at least a portion of the coating on the exposed peripheral surface of the at least one inner ring to volatilize and be removed from the at least one ring while also causing at least a portion of a carbon content of the carbon-containing coating to diffuse into the at least one outer ring.

In accordance with a method of the present teachings, there is contemplated that there may be steps employed for treating at least a portion of a surface of a bearing component (e.g., an outer surface of an inner ring of a rolling bearing and/or an inner surface of an outer ring of a rolling bearing). There may be a step of coating at least a portion of the surface of the bearing component with a carbon-containing composition. Such a step may be employed by spraying a liquid composition onto the surface, such as while the bearing component is being rotated, while the spraying element is being rotated, or both, so that a generally uniform coating of the composition is formed. Thereafter, the coated bearing component is rotated, while a laser beam is directed toward the coating composition (or the laser beam is rotated). The energy from the laser beam is sufficient so that it causes carbon from the carbon-containing composition to at least partially diffuse into the bearing component, and it may optionally form a graphite coating on the surface of the bearing component. Use of the above-noted apparatus embodiments (and those described elsewhere herein) is envisioned as within the method of the present teachings.

As will be seen, the present teachings provide a number of technical benefits, including but not limited to the ability to selectively control the properties of bearing components, the ability to impart lubricity to bearing components, the ability to control the homogeneity of treatment of a bearing component, the ability to achieve consistent and reproducible treatments of successively treated bearing components, the ability to scale for mass production of treated bearing components, or any combination of the foregoing.

Also among the benefits of the present teachings is that the teachings can be practiced free of any heat treatment steps (e.g., free of one or more steps of quenching and tempering) for an entire bearing component. The teachings can be practiced free of any step of inductive heating. The teachings can be practiced free of any step of applying a metal alloy precursor. The teachings can be practiced free of any electrochemical processing step. A self-lubricating bearing can be achieved in the absence of impregnating a porous structure with a lubricant.

### BRIEF DESCRIPTION OF THE DRAWINGS

The following is a brief description of the accompanying drawings. Though the drawings omit a housing, it should be recognized that a housing may optionally be employed, such as a housing that at least substantially (if not entirely) encloses the various assemblies depicted.

FIG. 1A is side sectional view of an apparatus of the present teachings for treating an outer surface of an inner bearing ring component.

FIG. 1B is a perspective view of a sub-assembly of an apparatus of the present teachings for treating an outer surface of an inner bearing ring component.

FIG. 1C is an exploded perspective view of the sub-assembly of FIG. 1B.

FIG. 2A is side sectional view of an apparatus of the present teachings for treating an inner surface of an outer bearing ring component.

FIG. 2B is a perspective view of a sub-assembly of an apparatus of the present teachings for treating an inner surface of an outer bearing ring component.

FIG. 2C is an exploded perspective view of the sub-assembly of FIG. 2B.

FIG. 3 is an illustration of an example of an arrangement of optical components for a laser beam emitter assembly.

### DETAILED DESCRIPTION

As required, detailed embodiments of the present teachings are disclosed herein; however, it is to be understood that the disclosed embodiments are merely exemplary of the teachings that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present teachings.

In general, and as will be appreciated from the description that follows, the present teachings pertain to an improved apparatus for providing a laser treated surface of a rolling bearing component, such as a steel rolling bearing component. In particular, the apparatus is configured for imparting a laser surface treatment to at least a portion of a surface of a rolling bearing component having a carbon-containing coating thereon. The laser surface treatment is such that it can cause an amount of the carbon-containing coating to diffuse into the rolling bearing component to a desired depth thereby selectively imparting a carbon gradient from the treated surface and may also leave a deposit of a graphitic coating on the treated surface. The present teachings also pertain to methods of imparting a laser surface treatment to at least a portion of a rolling bearing component. The methods as disclosed herein may be performed using the apparatus described herein, or may be performed using another apparatus, or more than one apparatus, capable of performing the method steps. Therefore, the methods disclosed herein are not limited to being performed using the apparatus (or any embodiment) as disclosed herein.

The apparatus may include a support housing structure. The support housing structure may include one or more components for adjusting an inclination angle of a rolling bearing component being treated. A rolling bearing carrier component (e.g., a spindle shaft, a casing, or some other structure that supportably engages (such as by friction, by an interference fit, or otherwise) the rolling bearing component) may be employed. The carrier component may have a longitudinal axis and a surface adapted to receive and engage at least one ring to be employed as part of a rolling bearing. A motor may be mounted to the support housing structure and coupled with the rolling bearing carrier, the motor being adapted for rotatably driving the carrier. A laser beam emitter may be adapted for emitting a laser beam that is aimed at an exposed surface of the ring. The laser beam may be emitted by a suitable laser source (e.g., a carbon dioxide laser). The laser source may be maintained in a fixed position, or it may be adapted for translation, relative to a bearing component that is being treated. As will be seen, the laser source may be part of an assembly that directs a beam onto a translatable mirror, which in turn reflects at least a portion of the beam through a lens that focuses the beam onto the bearing component being treated.

The carrier component is rotated while the at least one ring component is in generally opposing relationship with the beam emitted by the laser beam emitter so that energy from the beam causes at least a portion of the carbon-containing coating on the ring to volatilize and be removed while also causing at least a portion of a carbon content of the carbon-containing coating to diffuse into the bearing component.

As will be appreciated from the description herein, the support housing structure may include a base that is pivotally connected to a frame (e.g., at or near an end of the base) that carries the motor, and it may be adapted for adjusting the angle of the carrier component relative to the laser beam emitter. The support housing structure may include a frame that carries the motor. The frame may include at least one generally vertically disposed plate to which the motor can be mounted. The plate may have an aperture through which an output shaft of the motor, the carrier component, or both can penetrate.

The motor may be an electronically controllable servo motor. It may have an output shaft that projects outward from a housing of the motor. The output shaft may be adapted to be secured in driving relationship with the carrier component (e.g., a casing, a spindle shaft, or otherwise).

As indicated, the beam of the laser beam emitter may be adapted to be controllably translated in predetermined increments for directing the laser beam successively along a direction that is generally parallel with the longitudinal axis of the carrier component. The beam may be controlled for emission at an angle relative to the bearing component. For example, the beam may be aimed at one or more angles (a) of less than about 90′, less than about 60°, or even less than about 45° (e.g., about 5 to about 80′, about 10 to about 60°, or even about 15 to about 45°) relative to a plane of the bearing component that is generally transverse to its rotational axis.

The beam may be controlled for successively advancing the beam along the length of the bearing component being treated. It may be controlled to advance in regular increments, continuously, or both. It may be controlled for imparting a helical application of energy to the bearing component surface. It may be controlled for at least partially overlapping with a successive application of energy. By way of example, the laser beam emitter may be adapted to be controllably translate a beam as the bearing component is rotated, and the beam may be movable in increments for defining a helical surface treatment on the inner ring, with each 360° rotation generally corresponding with an incremental translation of the laser beam of from about 200 to about 400 μm (e.g., about 300 μm).

The laser beam emitter may be a carbon dioxide (CO₂) laser, capable of emitting a laser beam at a wavelength (A) of about 10.6 μm, at a power of about 50 watts (W) in a continuous mode operation, with a beam diameter of about 100 to about 200 μm (e.g., about 150 μm). The laser beam emitter may be capable of operation in a TEM₀₀ mode of operation, by radio frequency. The laser beam emitter may be suitably cooled, such as by being cooled by cooling water.

The teachings herein also contemplate a method of treating a bearing component. In accordance with a method of the present teachings, there is contemplated that there may be steps employed for treating at least a portion of a surface of a bearing component (e.g., an outer surface of an inner ring of a rolling bearing and/or an inner surface of an outer ring of a rolling bearing). There may be a step of coating at least a portion of the surface of the bearing component with a carbon-containing composition. Such a step may be employed by spraying a liquid composition onto the surface, such as while the bearing component is being rotated, while the spraying element is rotated, or both the bearing component and the spraying element are rotated relative to each other, so that a generally uniform coating of the composition is formed. Thereafter, the coated bearing component is rotated (and/or the laser beam may be directed to rotate), while a laser beam is directed toward the coating composition. The energy from the laser beam is sufficient so that it causes carbon from the carbon-containing composition to at least partially diffuse into the bearing component, and it may optionally form a graphite coating on the surface of the bearing component. Use of the above-noted apparatus embodiments (and those described elsewhere herein) is envisioned as within the method of the present teachings.

In more detail, it is contemplated that a bearing component may be coated with a carbon-containing composition. By way of example, the exposed outer peripheral surface of an inner ring component and/or the exposed inner peripheral surface of an outer ring component may be coated with a liquid coating composition that includes a carbon-containing material such as a plurality of ultrafine carbon containing particles (e.g., natural graphite particles, synthetic graphite particles, carbon black, or any combination thereof) with a median particle size below about 40, about 30, about 20, or even below about 10 μm (per ASTM E11-01 or ISO 3310-1(2000)). For example, the median particle size may be about 0.1 to about 40 μm, about 0.5 to about 25 μm, or even about 1 to about 10 μm (e.g., about 1, 3, 5, 7, or 9 μm). It is possible that the maximum particle size of at least 95% by weight may be below about 20 μm, 15 μm, or even below about 10 μm. The maximum particle size of about 50% by weight of the particles may be below about 10 μm, about 7 μm or even about 4 μm. The maximum particle size of about 10% by weight of the particles may be below about 4 μm, or even about 2 μm. The liquid coating composition may also include at least one coating agent adapted for (i) substantially uniformly dispersing the plurality of ultrafine carbon containing particles in a liquid medium (e.g., water, and/or an organic medium, such as an alcohol (e.g., methanol, ethanol, isopropanol, butanol, or some other short-chain or medium-chain alcohol), and/or a ketone (e.g., acetone)), and (ii) for imparting sufficient viscosity to the resulting liquid composition so that upon application of the liquid composition to the bearing component, the liquid composition forms a generally homogeneous coating layer in contact with a coated surface of the bearing component. The at least one coating agent may include a water soluble protein (e.g., albumin), a material containing collagen or a derivative thereof (e.g., gelatin powder), bone marrow, a polysaccharide or a polysaccharide-containing material (e.g., a mixture of at least one glycoprotein and at least one polysaccharide), such as a material selected from wheat starch, potato starch, corn starch, tapioca, a dextrin (such as maltodextrin), carboxymethylcellulose (and/or a salt or another derivative thereof), gum Arabic, wheat flour. or any combination thereof. The at least one coating agent may include a combination of at least one protein and at least one polysaccharide. The at least one coating agent may include a combination of two, three, four or more polysaccharides. For example, when the at least one coating agent includes a starch, it may be in combination with another starch. and/or in combination with a dextrin, a carboxymethylcellulose (and/or a salt or another derivative thereof), and/or gum Arabic. For example, the coating agent may include a combination of two or more starches (e.g., two or more of wheat starch, potato starch, corn starch and/or tapioca, such as one including corn starch and wheat starch); a combination of wheat starch, potato starch, tapioca, and/or corn starch with a dextrin (e.g., maltodextrin) and a combination of a dextrin (e.g., maltodextrin) with carboxymethylcellulose (and/or a salt or another derivative thereof), or some other combination within the above teachings. Other examples of combinations that may be included in the coating agent include a combination of at least one starch (e.g., wheat starch, potato starch, rice starch, corn starch, and/or tapioca (or another starch having an amylose content (by weight) of at least about 10% dry basis, or about 20% dry basis (e.g., about 20 to about 35% dry basis of the starch)) mixed with the carboxymethylcellulose (and/or a salt or another derivative thereof). For example, examples of a coating agent may include wheat starch with carboxymethylcellulose (and/or a salt or another derivative thereof), corn starch with carboxymethylcellulose (and/or a salt or another derivative thereof), or a combination of wheat starch and corn starch with carboxymethylcellulose (and/or a salt or another derivative thereof). The relative amounts of the two or more ingredients for the coating agent may be any suitable amount that achieves the desired characteristics. For example, in some applications, it is possible that approximately equal amounts by weight or volume of each coating agent ingredient may be employed. The at least one coating agent of the coating composition may be present in a weight ratio relative to the carbon-containing material (e.g., carbon-containing particles) of about 1:10 to about 1:1000 (e.g., about 1:50 to about 1:200, such as about 1:80, about 1:100, or about 1:120). The amount of carbon-containing material relative to the liquid medium (e.g., a short-chain alcohol, such as methanol, ethanol, and/or isopropanol) may range from about 0.5 to about 2 grams per about 50 milliliters (ml). about 0.5 to about 2 grams per about 20 ml or even about 0.5 to about 2 grams per about 10 ml (e.g., about 0.5 grams per about 10 ml, about 1 gram per about 10 ml, about 1.5 gram per about 10 ml, or about 2 grams per about 10 ml).

The coating may be performed by rotating the bearing component while spraying the liquid composition through a nozzle. The coating may be performed by rotating the nozzle while spraying the liquid composition through the nozzle. One or both of the bearing component and nozzle may be rotated. For example, the nozzle may be located at a distance of about 100 to about 500 mm from the bearing component surface (e.g., about 200 to about 400 mm, or even about 250 to about 300 mm). The bearing component and the nozzle may be rotated relative to each other at a rate of about 5 to about 50 rotations per minute, about 10 to about 30 rotations per minute (e.g., about 20 rotations per minute). The nozzle may be aimed so that its output is generally perpendicular to the workpiece, or it may be at one or more angles. For example, it may be aimed at an angle relative to a plane that is transverse to the axis of rotation of the bearing component of about 60 to about 90°. One or more layers may be applied. For example coating may be applied to define two, three or more layers having a total thickness (of all layers) of from about 0.5 to about 25 μm, about 2 to about 15 μm, or even about 3 to about 10 μm. Following laser treatment, it is envisioned that there will result in a layer of graphite being formed in situ. For example, it is envisioned that a layer of graphite formed has a thickness of about 0.1 to about 10 μm, or about 1 to about 7 μm, or even about 2 to about 5 μm (e.g., about 3 μm). Thus, the thickness of the coating is desirably selected so that it will achieve such resulting layer of in situ formed graphite. The coating step may be performed using the apparatus or in conjunction with the apparatus as disclosed herein. The coating step may be performed using another apparatus capable of performing the coating step.

After coating with the coating composition, the bearing component is located on the carrier. While located on the carrier, the bearing component may be rotated using the motor so that the bearing component rotates about its rotational axis. One or more steps of directing a laser beam onto the coating are employed while the bearing component rotates for causing the carbon in the composition to at least partially diffuse into the bearing component and for optionally forming a graphite coating on the outer peripheral surface of the inner ring.

The step of directing a laser beam may employ translationally advancing the laser beam so that it moves along a path generally parallel with the longitudinal axis of the carrier in a generally helical manner, with incremental translation advancements of approximately 200 to about 400 μm (e.g., about 300 μm) for one or more 360° rotations of the bearing component. As indicated, the method may include one or more steps of employing a carbon dioxide (CO₂) laser; emitting a laser beam at a wavelength (λ) of about 10.6 μm at a power of about 50 watts (W) in a continuous mode operation; emitting a laser beam with a beam diameter of about 100 to about 200 μm (e.g., about 150 μm); operating the laser beam to a beam at a focal distance (defined as the distance from the closest surface of the focusing lens to the bearing component) of about 150 to about 200 mm (e.g., about 170 mm); operating the laser beam at a scan speed of about 50 to about 150 mm/second (e.g., about 100 mm/second); operating the laser beam at a fluency of about 4 to about 6×10⁶ J/m²; operating the laser beam in TEM₀₀ mode of operation, by radio frequency and/or cooling the laser beam emitter with a fluid (e.g., water). The step of directing the laser beam includes a step of reflecting the laser beam off of at least one mirror and through at least one lens, and translating the at least one mirror and at least one lens in a direction generally parallel with the longitudinal axis of the carrier component (e.g., the casing, the spindle shaft or other such component). The method may be performed with or in conjunction with the apparatus as disclosed herein, or another apparatus (or more than one apparatus) capable of performing the method.

The method may also include a step of assembling an inner ring (e.g., one produced in accordance with the present teachings) with an outer ring (e.g., one produced in accordance with the present teachings), with at least one rolling body therebetween for forming a rolling bearing. Again, as noted, the method may be performed with or in conjunction with the apparatus as disclosed herein, or another apparatus (or more than one apparatus) capable of performing the method.

In one aspect the apparatus may be in the form of an embodiment adapted for treating an outer surface of an inner ring of a rolling bearing component, or an inner surface of an outer ring of a rolling bearing component. For example, in one aspect, there is envisioned an apparatus for imparting a laser surface treatment to an exposed outer peripheral surface of an inner ring of a rolling bearing having a carbon-containing coating thereon. The apparatus includes a support housing structure, a spindle shaft having a longitudinal axis and an outer surface adapted to receive and engage at least one inner ring of the rolling bearing; and a motor mounted to the support housing structure and coupled with the spindle shaft, the motor being adapted for rotatably driving the spindle shaft. The apparatus may include a laser beam emitter adapted for emitting a laser beam that is aimed at the exposed peripheral surface of the at least one inner ring. In this manner the spindle shaft may be rotated while the at least one rolling bearing is in generally opposing relationship with the beam of the laser beam emitter so that energy from the beam causes at least a portion of the coating on the exposed peripheral surface of the at least one inner ring to volatilize and be removed from the at least one ring while also causing at least a portion of a carbon content of the carbon-containing coating to diffuse into the at least one inner ring.

The spindle shaft may be generally cylindrical having a first outer diameter along at least a portion (e.g., a majority) of its length, a proximal end that adjoins the motor and a distal end. The spindle shaft may optionally include a shoulder located toward the proximal end that adjoins a portion of the spindle shaft having a second outer diameter that is larger than the first outer diameter, wherein the first outer diameter corresponds with an inner diameter of the at least one inner ring so that the at least one inner ring is generally held in frictional engagement with the spindle shaft. The spindle shaft may be sufficiently long that it can receive a plurality of inner rings. The spindle shaft may include a cover plate at the distal end for securing any inner rings carried on the spindle shaft, the cover plate including a projecting stem that inserts into a bore of the spindle shaft (e.g., frictionally and/or threadedly).

As will be appreciated, a method of using such an apparatus for laser treating an inner ring of a bearing may include coating an outer peripheral surface of the inner ring with the above taught coating composition that includes carbon. There may be steps of locating the inner ring on the spindle shaft, rotating the spindle shaft using the motor so that the inner ring rotates, and directing a laser beam onto the coating while the inner ring rotates for causing the carbon to at least partially diffuse into the inner ring and for optionally forming a graphite coating on the outer peripheral surface of the inner ring.

In another aspect, there is envisioned an apparatus for imparting a laser surface treatment to an exposed inner peripheral surface of an outer ring of a rolling bearing having a carbon-containing coating thereon. Such apparatus includes a support housing structure, a casing having a longitudinal axis and an inner surface adapted to receive and engage an outer surface of at least one outer ring of the rolling bearing; and a motor mounted to the support housing structure and coupled with the casing, the motor being adapted for rotatably driving the casing. The apparatus may include a laser beam emitter adapted for emitting a laser beam that is aimed at the exposed inner peripheral surface of the at least one outer ring at an angle that is generally not perpendicular to the longitudinal axis of the casing. In this manner, the casing may be rotated while the at least one rolling bearing is in generally opposing relationship with the beam of the laser beam emitter so that energy from the beam causes at least a portion of the coating on the exposed peripheral surface of the at least one inner ring to volatilize and be removed from the at least one ring while also causing at least a portion of a carbon content of the carbon-containing coating to diffuse into the at least one outer ring.

The support housing structure may include a base that is pivotally connected to a frame that carries the motor and is adapted for adjusting the angle of the spindle shaft relative to the laser beam emitter, such as by one or more optional inclination control members that controllably cause the frame to move relative to the base. The support housing structure includes a frame that carries the motor, the frame including at least one generally vertically disposed plate to which the motor can be mounted, the plate having an aperture through which an output shaft of the motor, the casing, or both can penetrate. The support housing structure may include a base that is pivotally connected to a frame that carries the motor generally at one end of one or both of the base or the frame, and at least one inclination control member penetrates the base and can be controllably operated to be raised or lowered for causing the frame to raise or lower.

The casing may be generally cylindrical having a first inner diameter along at least a portion (e.g., a majority) of its length and a proximal end that adjoins a coupling for connecting with an output shaft of the motor, wherein the first inner diameter corresponds with an outer diameter of the at least one outer ring so that the at least one outer ring is generally held at least partially within (e.g., in frictional engagement with) the casing. The casing may be sufficiently long that it can receive a plurality of outer rings. The casing may be coupled with an output shaft of the motor by a coupling that includes a plurality of radial projections that interconnect with a shaft portion extending from the proximal end of the casing.

The beam of the laser beam emitter may be adapted to be controllably translated in predetermined increments for directing the laser beam successively along the longitudinal axis of the casing at an angle relative to the longitudinal axis of the casing, such as at an angle (α) that is relative to a plane that is transverse to the axis of rotation of the bearing component.

A method for laser treating an outer ring of a bearing component thus may include steps of coating an inner peripheral surface of the outer ring with a coating composition that includes carbon as described. There may be a step of locating the outer ring in the casing. There may be a step of rotating the casing using the motor so that the outer ring rotates. There may be a step of directing a laser beam onto the coating while the outer ring rotates for causing the carbon to at least partially diffuse into the outer ring and for optionally forming a graphite coating on the inner peripheral surface of the outer ring.

Resulting rolling bearing components prepared using the apparatus and/or method of the teachings herein will typically include a surface portion adapted for contacting a rolling body. A mass will adjoin and terminate at the surface. The surface may be characterized by a plurality of visible overlapping striped regions that is generally devoid of any surface erosion. The mass may include a first region having a depth of about 50 to about 200 micrometers and having a first carbon content. The mass may include a second region beneath and generally adjoining the first region having a depth of about 50 to about 100 micrometers and having a second carbon content that is less than the carbon content of the first region. The mass may include a third region beneath and generally adjoining the second region having a third carbon content that is less than the carbon content of the first and the second region. One or more generally continuous gradients of carbon content and hardness may exist from the surface portion to the third region, with both carbon content and hardness decreasing moving from the surface portion to the third region. A layer of graphite may exist on the surface portion. Thus, it is seen that progressing from the surface to the third region there is a generally continuous decrease in the amount of carbon and the hardness, until a generally constant amount of carbon and hardness is realized in the third region.

The bearing component may exhibit certain other physical appearances or characteristics that allow the respective regions to be distinguished relative to one another. This may be determined metallographically. For example, the first region may be distinguishable from the second region by a visible color change upon etching (e.g., by way of etching in accordance with ASTM E407-07e1, such as by using a picral etch, a nital etch, or the like). The third region may be distinguishable from the second region and the first region by the presence in the third region of a generally constant hardness, and a generally constant carbon content (e.g., an average content that fluctuates in the third region between a maximum and minimum content by an amount below about 15%, 10%, or even 5% of the average content). Microstructure may also vary in a manner to render it possible to ascertain the different regions. For instance, the first region may have a higher average content of martensite relative to the average content (by volume) of martensite in the second and third regions. The second region may have an average content of martensite below that of the first region and higher than that of the third region. The third region may have a generally constant content of martensite (e.g., an average content that fluctuates in the third region between a maximum and minimum content by an amount below about 15%, 10%, or even 5% of the average content). The third region may also be characterized has having a generally uniform presence of martensite and austenite phases. The boundary between regions may also be determined (or confirmed (based upon metallographic inspection)) by x-ray diffraction techniques for identifying the presence of different peaks (which correspond with different phases) across a section of the bearing component. For example, the third region may have an x-ray diffraction (XRD) pattern that is generally characteristic of the starting bearing material. The second region, in turn, may show phases from the third region, with the addition of peaks corresponding to the presence of additional elements or phases. For example, the second region may exhibit a more intense peak corresponding with carbon than any carbon corresponding peak in the third region. In addition, or in the alternative, the second region may exhibit the presence of a more pronounced peak (believed to correspond with α (110)) at a 2θ value of about 75° than that of the third region. As well, there may be noticed the presence of a relatively pronounced peak at a 28 value of about 26° than that of the third region. The first region is expected to exhibit a plurality of relatively pronounced peaks corresponding with the presence of carbon than found in the second and third regions.

As can be appreciated from the above, the apparatus and method teachings herein also contemplate that one or more electronic control devices may be employed for operating one or more of the components. For example, one or more control devices may be employed for synchronizing the application of laser energy with rotation of a carrier, for adjusting the translation of the bearing component and the laser beam relative to each other, for adjusting rotation rates, for adjusting a laser operational parameter, or any combination thereof.

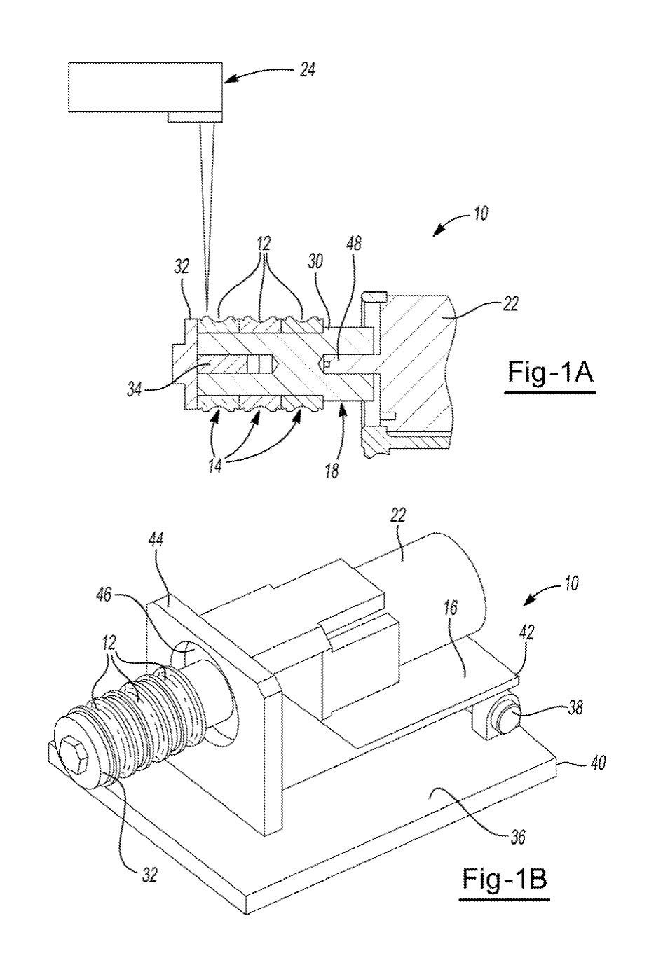

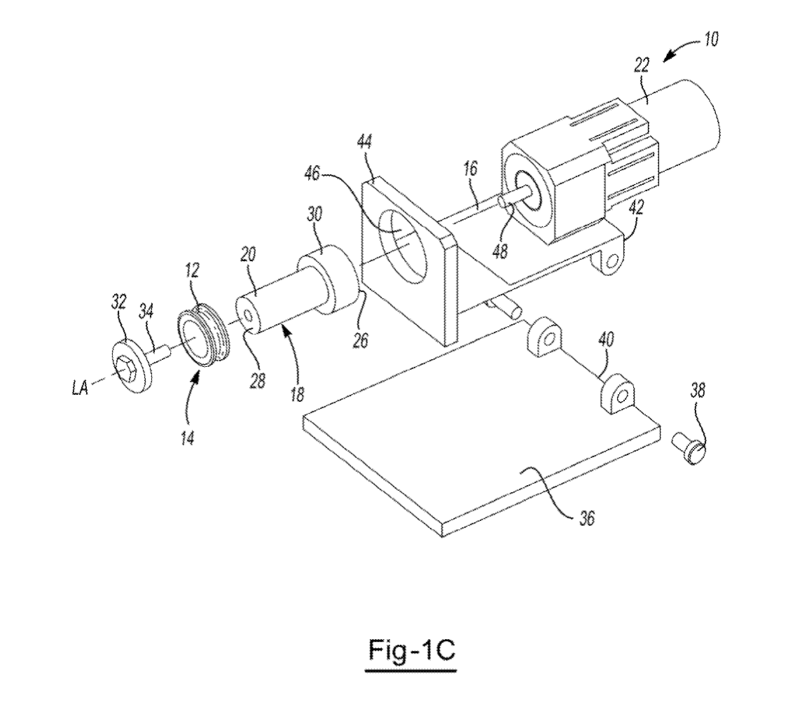

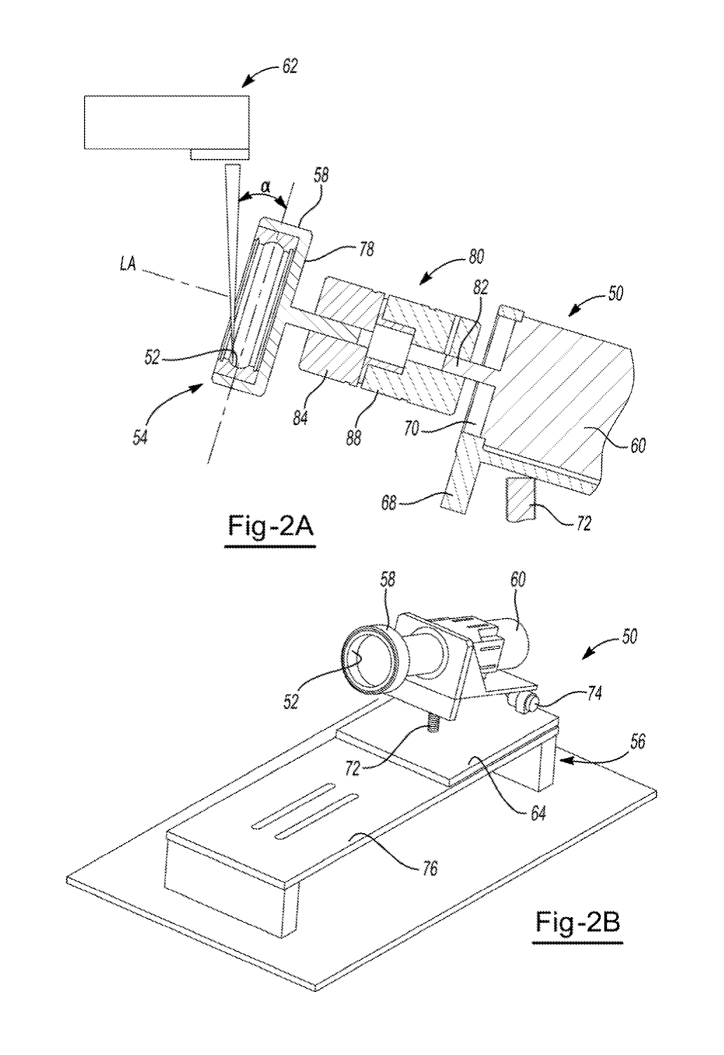

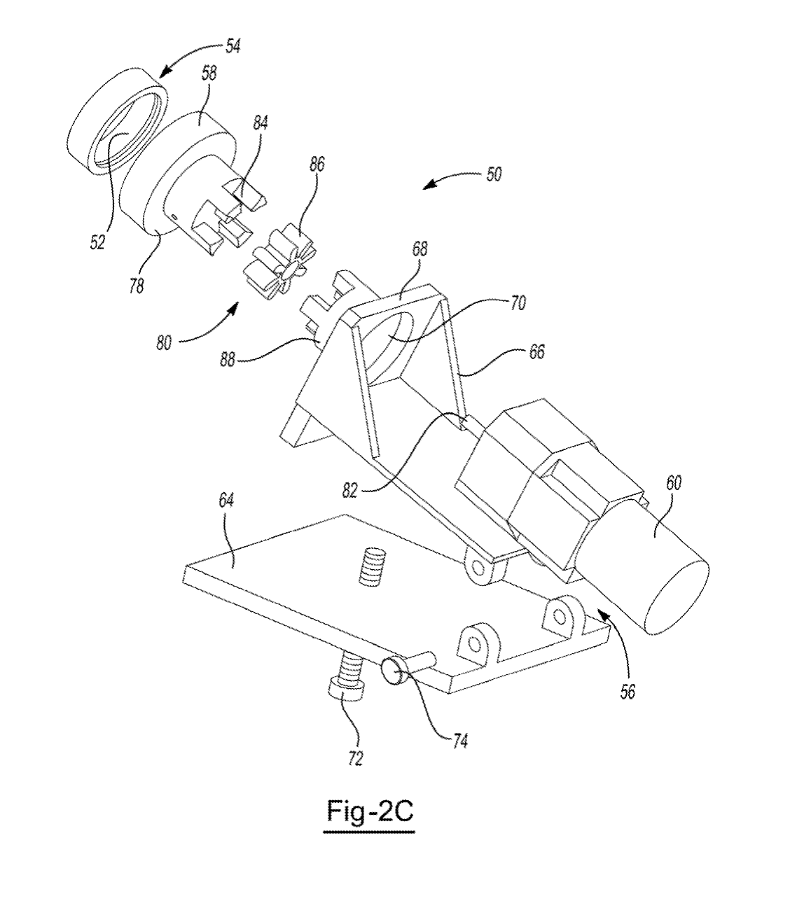

Turning now to the drawings for examples within the scope of the present teachings, reference is made first to FIGS. 1A-1C, which pertain to assemblies that may be employed for treating an outer peripheral surface of an inner ring of a ring bearing. As with the teachings in FIGS. 2A-2C, though a housing may enclose some or all of the components, it is omitted from the drawings.

An apparatus 10 for imparting a laser surface treatment to an exposed outer peripheral surface 12 of an inner ring 14 of a rolling bearing having a carbon-containing coating thereon. The apparatus 10 includes a support housing structure 16, a spindle shaft 18 having a longitudinal axis (LA) and an outer surface 20 adapted to receive and engage at least one inner ring of the rolling bearing. A motor 22 is mounted to the support housing structure and coupled with the spindle shaft. The motor 22 is adapted for rotatably driving the spindle shaft 18.

The apparatus include a laser beam emitter 24 adapted for emitting a laser beam that is aimed at the exposed peripheral surface of the at least one inner ring. In this manner the spindle shaft may be rotated while the at least one rolling bearing is in generally opposing relationship with the beam of the laser beam emitter so that energy from the beam causes at least a portion of the coating on the exposed peripheral surface of the at least one inner ring to volatilize and be removed from the at least one ring while also causing at least a portion of a carbon content of the carbon-containing coating to diffuse into the at least one inner ring.

The spindle shaft is shown as generally cylindrical having a first outer diameter along at least a portion (e.g., a majority) of its length, a proximal end 26 that adjoins the motor, and a distal end 28. The spindle shaft is shown to include a shoulder 30 located toward the proximal end that adjoins a portion of the spindle shaft having a second outer diameter that is larger than the first outer diameter, wherein the first outer diameter corresponds with an inner diameter of the at least one inner ring so that the at least one inner ring is generally held in frictional engagement with the spindle shaft. The spindle shaft may be sufficiently long that it can receive a plurality of inner rings. The spindle shaft may include a cover plate 32 at the distal end for securing any inner rings carried on the spindle shaft. The cover plate includes a projecting stem 34 that inserts into a bore of the spindle shaft (e.g., frictionally and/or threadedly).

The support housing structure 16 is pivotally attached to a support table 36, such as by pins 38 that penetrate through opposing openings in projections formed respectively in the support housing structure and the support table. As seen in FIGS. 1B and 1C, the pivotal connection is located proximate a first end 40 of the support table 36 and a first end 42 of the support housing structure 16. The support housing structure has a generally vertical plate 44 that has an opening 46 through which the spindle, the motor or both may penetrate. The motor may engage the spindle shaft by way of an output shaft 48.

Turning now to FIGS. 2A-2C, there is depicted an apparatus 50 for imparting a laser surface treatment to an exposed inner peripheral surface 52 of an outer ring 54 of a rolling bearing having a carbon-containing coating thereon. Such apparatus includes a support housing structure 56. A casing 58 having a longitudinal axis (LA) also has an inner surface adapted to receive and engage an outer surface of at least one outer ring of the rolling bearing. A motor 60 is mounted to the support housing structure 56 and coupled with the casing, with the motor being adapted for rotatably driving the casing. The apparatus includes a laser beam emitter 62 adapted for emitting a laser beam that is aimed at the exposed inner peripheral surface of the at least one outer ring at an angle (a) that is generally not perpendicular to the longitudinal axis of the casing. In this manner, the casing may be rotated while the at least one rolling bearing is in generally opposing relationship with the beam of the laser beam emitter so that energy from the beam causes at least a portion of the coating on the exposed peripheral surface of the at least one outer ring to volatilize and be removed from the at least one ring while also causing at least a portion of a carbon content of the carbon-containing coating to diffuse into the at least one outer ring.

The support housing structure 56 may include a base 64 that is pivotally connected to a frame 66 having a vertical plate 68 with an opening 70 (through which an output shaft of the motor, the casing, or both can penetrate), which carries the motor, and is adapted for adjusting the angle of casing relative to the laser beam emitter, such as by one or more inclination control members 72 that controllably bears against the frame 66 and causes the frame to move relative to the base 64. As with the embodiment of FIGS. 1A-1C, the frame 66 may be pivotally connected to the base by way of pins 74. The base 64 may be supported by a support frame 76 that elevates the base 64 sufficiently so that the inclination control member 72 can be raised or lowered (e.g., manually or automatically, such as by a motor or other actuator) without interference.

The casing is generally cylindrical and has an inner diameter along at least a portion (e.g., a majority) of its length. It has a proximal end 78 that adjoins a coupling 80 for connecting with an output shaft 82 of the motor. The first inner diameter corresponds with an outer diameter of the at least one outer ring so that the at least one outer ring is generally held at least partially within (e.g., in frictional engagement with) the casing. The casing may be sufficiently long that it can receive a plurality of outer rings. The casing may be coupled with an output shaft of the motor by the coupling 80, which coupling 80 interconnects with a first shaft portion 84 extending from the proximal end of the casing, and includes a plurality of radial projections 86. A second shaft portion 88 may couple the output shaft 82 of the motor with the coupling as well in like manner.

The beam of the laser beam emitter may be adapted to be controllably translated in predetermined increments for directing the laser beam successively along the longitudinal axis of the casing at an angle relative to the longitudinal axis of the casing, such as at an angle (α) that is relative to a plane that is transverse to the axis of rotation of the bearing component.

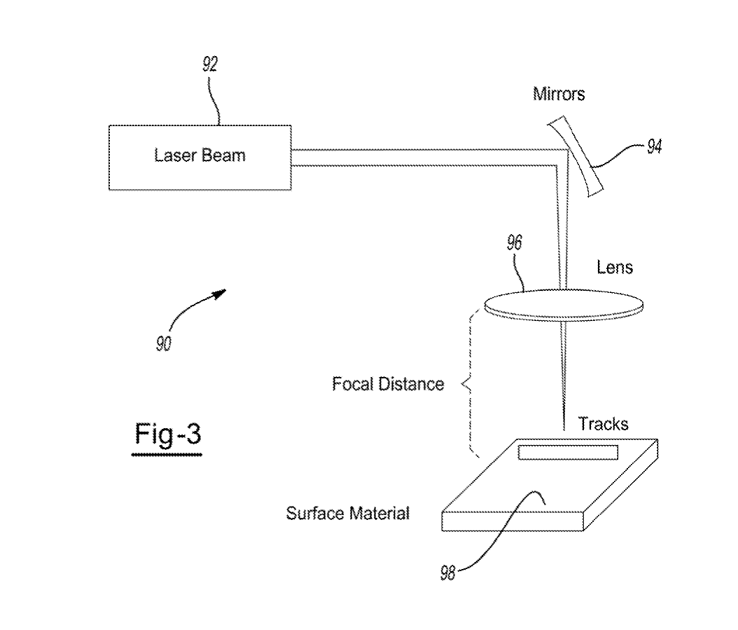

With reference to FIG. 3, there is seen an example of a laser beam emitter assembly 90 that may be employed in the present teachings. A laser beam source 92 emits a beam that is at least partially reflected by one or more mirrors 94. so that the beam passes through one or more lenses 96 for focusing the beam onto the bearing component (referred to in the drawing as “surface material” (element 98)). The mirrors, the lenses or both can be controllably moved in order to translate the beam in a desired direction (and thus form the “tracks” of the beam).

In accordance with the present teachings it is thus seen how it may be possible to achieve a bearing component (e.g., an inner and/or outer ring of a rolling bearing) having relatively hard surface that is free of surface ablation or fusion, and which may have a resulting coefficient of friction that is reduced by at least about one third, one half, or two thirds of its initial coefficient of friction prior to the treatment according to the present teachings. The surface hardness may be increased at least about 10%, 20%, 30% or higher relative to the initial surface hardness prior to the treatment according to the present teachings.

The teachings herein contemplate that improved bearings can be realized in the absence of treating the bearings to impart a surface texture, the absence of impregnating a porous structure with a lubricant, the absence of sintering under high temperature and pressure, the absence of applying energy in an amount that causes the metal of the bearing to at least partially melt, the absence of any liquid phase arising during treatment, the absence of any quenching step, the absence of any post-laser treatment tempering step, or any combination thereof; the absence of a step of physical vapor deposition and/or chemical vapor deposition; the absence of a ceramic material layer; the absence of any diamond like carbon surface; the absence of any added metal layer.

Chemical analysis of materials can be performed using energy-dispersive X-ray spectroscopy. Metallographic inspection may employ conventional sectioning, mounting, grinding, polishing and etching (e.g., with 2% Picral etch) for revealing microstructure through an optical microscope. Optionally, inspection may be made using a scanning electron microscope (e.g., for analyzing the morphology of a resulting layer of graphite deposited onto a surface).

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight, and vice versa. Thus, an expression in the Detailed Description of the Invention of a range in terms of at “‘x’ parts by weight of the resulting composition” also contemplates a teaching of ranges of same recited amount of “x” in percent by weight of the resulting composition. Relative proportions derivable by comparing relative parts or percentages are also within the teachings, even if not expressly recited.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of, or even consisting of, the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

Relative positional relationships of elements depicted in the drawings are part of the teachings herein, even if not verbally described. Further, geometries shown in the drawings (though not intended to be limiting) are also within the scope of the teachings, even if not verbally described.

What is claimed is:

1) An apparatus for imparting a laser surface treatment to an exposed outer peripheral surface of at least one inner ring of a rolling bearing having a carbon-containing coating thereon, comprising:
a. a support housing structure;
b. a spindle shaft having a longitudinal axis and an outer surface adapted to receive and engage at least one inner ring of the rolling bearing; and
c. a motor mounted to the support housing structure and coupled with the spindle shaft, the motor being adapted for rotatably driving the spindle shaft;
d. a laser beam emitter adapted for emitting a laser beam that is aimed at the exposed outer peripheral surface of the at least one inner ring;
e. wherein the spindle shaft is rotated while the rolling bearing is in generally opposing relationship with the laser beam of the laser beam emitter so that energy from the laser beam causes at least a portion of the carbon-containing coating on the exposed outer peripheral surface of the at least one inner ring to volatilize and be removed from the at least one inner ring while also causing at least a portion of a carbon content of the carbon-containing coating to diffuse into the at least one inner ring.

2) The apparatus of claim 1, wherein the support housing structure includes a base that is pivotally connected to a frame that carries the motor, and being adapted for adjusting an angle of the spindle shaft relative to the laser beam emitter.

3) (canceled)

4) (canceled)

5) The apparatus of claim 1, wherein the spindle shaft is generally cylindrical having a first outer diameter along at least a portion of its length, has a proximal end that adjoins the motor and a distal end, and optionally includes a shoulder located toward the proximal end that adjoins a portion of the spindle shaft having a second outer diameter that is larger than the first outer diameter, wherein the first outer diameter corresponds with an inner diameter of the at least one inner ring so that the at least one inner ring is generally held in frictional engagement with the spindle shaft.

6) (canceled)

7) (canceled)

8) (canceled)

9) The apparatus of claim 1, wherein the laser beam of the laser beam emitter is adapted to be controllably translated in predetermined increments for directing the laser beam successively in a direction that is generally parallel with or along the longitudinal axis of the spindle shaft.

10) The apparatus of claim 1, wherein the laser beam emitter is adapted to be controllably translated as the at least one inner ring of the rolling bearing is rotated by the spindle shaft and is movable in increments for defining a helical surface treatment on the at least one inner ring, with each 360° rotation generally corresponding with an incremental translation of the laser beam of from about 200 to about 400 μm.

11) The apparatus of claim 1, wherein the laser beam emitter is a carbon dioxide (CO₂) laser, capable of emitting a laser beam at a wavelength (λ) of about 10.6 μm, at a power of about 50 watts (W) in a continuous mode operation, with a beam diameter of about 100 to about 200 μm, and optionally wherein the laser beam emitter is capable of operation in a TEM₀₀ mode of operation, by radio frequency and being cooled by cooling water.

12) The apparatus of claim 1, wherein the laser beam emitter is part of an assembly that includes at least one translatable mirror, and at least one translatable lens, the at least one translatable mirror and the at least one translatable lens being controllably positioned so that the laser beam emitted can be reflected by the at least one translatable mirror through the at least one translatable lens and the at least one translatable lens focuses the resulting reflected laser beam onto the at least one inner ring, and the at least one translatable mirror and at least one translatable lens allows the laser beam emitter to remain in a fixed position while still permitting the laser beam to be advanced in a direction generally parallel with the longitudinal axis of the spindle shaft.

13) (canceled)

14) (canceled)

15) (canceled)

16) (canceled)

17) (canceled)

18) (canceled)

19) (canceled)

20) (canceled)

21) An apparatus for imparting a laser surface treatment to an exposed inner peripheral surface of at least one outer ring of a rolling bearing having a carbon-containing coating thereon, comprising:
a. a support housing structure;
b. a casing having a longitudinal axis and an inner surface adapted to receive and engage an outer surface of at least one outer ring of the rolling bearing; and
c. a motor mounted to the support housing structure and coupled with the casing, the motor being adapted for rotatably driving the casing; and
d. a laser beam emitter adapted for emitting a laser beam that is aimed at the exposed inner peripheral surface of the at least one outer ring at an angle that is generally not perpendicular to the longitudinal axis of the casing;
wherein the casing is rotated while the rolling bearing is in generally opposing relationship with the laser beam of the laser beam emitter so that energy from the laser beam causes at least a portion of the carbon-containing coating on the exposed inner peripheral surface of the at least one outer ring to volatilize and be removed from the at least one outer ring while also causing at least a portion of a carbon content of the carbon-containing coating to diffuse into the at least one outer ring.

22) The apparatus of claim 21, wherein the support housing structure includes a base that is pivotally connected to a frame that carries the motor, and being adapted for adjusting the angle of the casing relative to the laser beam emitter by one or more inclination control members that controllably causes the frame to move relative to the base.

23) (canceled)

24) (canceled)

25) The apparatus of claim 21, wherein the casing is generally cylindrical having a first inner diameter along at least a portion of its length, has a proximal end that adjoins a coupling for connecting with an output shaft of the motor, wherein the first inner diameter corresponds with an outer diameter of the at least one outer ring so that the at least one outer ring is generally held in frictional engagement with the casing.

26) (canceled)

27) The apparatus of claim 21, wherein the casing is coupled with an output shaft of the motor by a coupling that includes a plurality of radial projections that interconnect with a shaft portion extending from a proximal end of the casing.

28) The apparatus of claim 21, wherein the motor is an electronically controllable servo motor, the motor has an output shaft that projects outward from a housing of the motor, and the output shaft is adapted to be secured in driving relationship with the casing.

29) The apparatus of claim 21, wherein the laser beam of the laser beam emitter is adapted to be controllably translated in predetermined increments for directing the laser beam successively in a direction that is generally parallel with or along the longitudinal axis of the casing at an angle (α) of about 15° to about 45° relative to an axis that is transverse to the longitudinal axis of the casing.

30) The apparatus of claim 21, wherein the laser beam emitter is adapted to be controllably translated as the at least one outer ring of the roller bearing is rotated by the casing and is movable in increments for defining a helical surface treatment on the outer ring, with each 360° rotation generally corresponding with an incremental translation of the laser beam of from about 200 to about 400 μm.

31) The apparatus of claim 21, wherein the laser beam emitter is a carbon dioxide (CO₂) laser, capable of emitting a laser beam at a wavelength (λ) of about 10.6 μm, at a power of about 50 watts (W) in a continuous mode operation, with a beam diameter of about 100 to about 200 μm, and optionally wherein the laser beam emitter is capable of operation in a TEM₀₀ mode of operation, by radio frequency and being cooled by cooling water.

32) The apparatus of claim 21, wherein the laser beam emitter is part of an assembly that includes at least one translatable mirror, and at least one translatable lens, the at least one translatable mirror and the at least one translatable lens being controllably positioned so that the laser beam emitted can be reflected by the at least one translatable mirror through the at least one translatable lens and the at least one translatable lens focuses the resulting reflected laser beam onto the at least one outer ring, and the at least one translatable mirror and at least one translatable lens allows the laser beam emitter to remain in a fixed position while still permitting the laser beam to be advanced in a direction generally parallel with the longitudinal axis of the casing.

33) (canceled)

34) A method for laser treating a ring of a bearing comprising:
a. using apparatus coating the ring with a coating composition that includes carbon,
wherein the ring is an outer ring of a bearing or an inner ring of a bearing,
wherein the coating is on an inner peripheral surface of the outer ring or an outer peripheral surface of an inner ring,
wherein the apparatus includes an element for supporting the ring,
wherein the element is a spindle shaft adapted to receive and engage the inner ring or a casing adapted to receive and engage an outer surface of the outer ring,
b. locating the ring on or in the element for supporting the ring;
c. rotating the element using the motor so that the ring rotates; and
d. directing a laser beam onto the carbon-containing coating while the ring rotates for causing the carbon to at least partially diffuse into the ring and for optionally forming a graphite coating on a surface of the ring.

35) The method of claim 34, wherein a step is employed of translationally advancing the laser beam so that it moves along a path generally parallel with a longitudinal axis of the spindle shaft or the casing in a generally helical manner, with incremental translation advancements of approximately 200 to about 400 μm for one or more 360° rotations of the inner ring, and wherein the method further includes:
a. employing a carbon dioxide (CO₂) laser;
b. emitting a laser beam at a wavelength (λ) of about 10.6 μm at a power of about 50 watts (W) in a continuous mode operation;
c. emitting the laser beam with a beam diameter of about 100 to about 200 μm;
d. operating the laser beam to a beam at a focal distance of about 150 to about 200 mm;
e. operating the laser beam at a scan speed of about 50 to about 150 mm/second;
f. operating the laser beam at a fluency of about 4 to about 6×10⁶ J/m²;
g. operating the laser beam in TEM₀₀ mode of operation, by radio frequency and/or cooling the laser beam emitter with a fluid
h. or a combination of a. through g.

36) The method of claim 34, wherein the step of directing the laser beam includes a step of reflecting the laser beam off of at least one mirror and through at least one lens, and translating the at least one mirror and at least one lens in a direction generally parallel with the longitudinal axis of the spindle shaft or the casing.

37) The method of claim 34, wherein the method includes assembling an inner ring with an outer ring, with at least one rolling body therebetween for forming a rolling bearing.

38) (canceled)

39) (canceled)

40) (canceled)
